(19) United States
(12) Patent Application Publication
(10) Pub. No.: US 2013/0135318 A1
(43) Pub. Date: May 30, 2013

(54) DISPLAY ASSEMBLIES AND METHODS OF FABRICATION THEREOF

(71) Applicants: Kollengode Subramanian NARAYANAN, Cupertino, CA (US); Ion BITA, San Jose, CA (US); Suryaprakash GANTI, Sunnyvale, CA (US); Brian William ARBUCKLE, Danville, CA (US)

(72) Inventors: Kollengode Subramanian NARAYANAN, Cupertino, CA (US); Ion BITA, San Jose, CA (US); Suryaprakash GANTI, Sunnyvale, CA (US); Brian William ARBUCKLE, Danville, CA (US)

(73) Assignee: QUALCOMM MEMS TECHNOLOGIES, INC., San Diego, CA (US)

(21) Appl. No.: 13/306,723

(22) Filed: Nov. 29, 2011

(51) Int. Cl. G06T 1/00; G02F 1/01; H01J 9/00; G02B 26/00

(52) U.S. Cl. 345/501; 359/290; 359/238; 445/24

(57) ABSTRACT

This disclosure provides systems, methods and apparatus for display assemblies. In one aspect, a display assembly may include a first panel, a second panel, and a third panel. The second panel may be spaced apart from the first panel, and the third panel may be spaced apart from the second panel. A first perimeter frame may join the first panel and the second panel, with the first perimeter frame defining a first cavity in between the first panel and the second panel. The first cavity may be substantially filled with a first liquid. A second perimeter frame may join the second panel and the third panel, with the second perimeter frame defining a second cavity in between the second panel and the third panel. The second cavity may be substantially filled with a second liquid.

### TECHNICAL FIELD

This disclosure relates generally to display assemblies and more particularly to display assemblies including electromechanical systems display devices.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

EMS display devices, including IMODs, may be used as part of a display assembly. For example, a display assembly may include a number of different panels, such as a display panel including IMODs or other EMS display devices, an illumination panel (e.g., to illuminate IMODs or other EMS display devices), a touch panel (e.g., so that the display assembly may function as a touch screen display), and a cover panel.

### SUMMARY

The systems, methods and devices of the disclosure each have several innovative aspects, no single one of which is solely responsible for the desirable attributes disclosed herein.

One innovative aspect of the subject matter described in this disclosure can be implemented in a display assembly. A display assembly may include a first panel, a second panel spaced apart from the first panel, and a third panel spaced apart from the second panel. A first perimeter frame may join the first panel and the second panel, with the first perimeter frame defining a first cavity in between the first panel and the second panel. The first cavity may be substantially filled with a first liquid. A second perimeter frame may join the second panel and the third panel, with the second perimeter frame defining a second cavity in between the second panel and the third panel. The second cavity may be substantially filled with a second liquid.

In some implementations, the second panel may be spaced apart from the first panel by about 5 microns to 300 microns and the third panel may be spaced apart from the second panel by about 5 microns to 300 microns. In some implementations, the first panel may include a display panel and the second panel may include an illumination panel. The illumination panel may be optically coupled to a light source to illuminate the display panel.

Another innovative aspect of the subject matter described in this disclosure can be implemented in a display assembly. A display assembly may include a first panel, a second panel, and a third panel. A first perimeter frame may join the first panel and the second panel, with the first perimeter frame defining a first cavity in between the first panel and the second panel. The first cavity may be substantially filled with a first solid. A second perimeter frame may join the second panel and the third panel, with the second perimeter frame defining a second cavity in between the second panel and the third panel. The second cavity may be substantially filled with a second solid.

In some implementations, the first solid may be about 5 microns to 300 microns thick, and the second solid may be about 5 microns to 300 microns thick. In some implementations, the first panel may include a display panel and the second panel may include an illumination panel. The illumination panel may be optically coupled to a light source to illuminate the display panel.

Another innovative aspect of the subject matter described in this disclosure can be implemented in a method of fabricating a display assembly. A first perimeter frame may be formed on a first panel of a display assembly. A second panel may be attached to the first perimeter frame. The first panel, the second panel, and the first perimeter frame may form a first cavity, with the first perimeter frame including a first opening to allow access to the first cavity. A second perimeter frame may be formed on the second panel. A third panel may be attached to the second perimeter frame. The second panel, the third panel, and the second perimeter frame may form a second cavity, with the second perimeter frame including a second opening to allow access to the second cavity. The first cavity and the second cavity may be simultaneously filled with a liquid using the first opening and the second opening to substantially fill the first cavity and the second cavity.

In some implementations, after filling the first cavity and the second cavity with the liquid, the liquid may be treated to alter the physical properties of the liquid. The liquid may be treated with a heat treatment of an ultraviolet light treatment. In some implementations, after filling the first cavity and the second cavity with the liquid, the first opening may be sealed and the second opening may be sealed.

In some implementations, the first panel may include a display panel and the second panel may include an illumination panel. The illumination panel may be optically coupled to a light source to illuminate the display panel.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIGS. 9A-9E show examples of schematic diagrams of display assemblies.

FIG. 10 shows an example of a flow diagram illustrating a manufacturing process for a display assembly.

FIGS. 11 and 12 show examples of schematic diagrams of a display assembly as described in FIG. 10 at various stages in the process.

FIGS. 13A and 13B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., electromechanical systems (EMS), MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, electronic test equipment. Thus, the teachings are not intended to be limited to the implementations depicted solely in the Figures, but instead have wide applicability as will be readily apparent to one having ordinary skill in the art.

Some implementations described herein relate to display assemblies. A display assembly may include a number of different panels. For example, a display assembly may include a display panel, a touch panel, and a cover panel. The display panel may be a panel that is capable of generating an image. The touch panel may be a device that can detect touch. The touch panel combined with the display panel may form a touch screen display in the display assembly. The cover panel may protect the display panel and the touch panel. When the display panel includes EMS reflective display devices, such as IMODs, the display assembly also may include an illumination panel that may illuminate the reflective display devices when there is not sufficient ambient light.

In some implementations described herein, a display assembly may include a first panel, a second panel, and a third panel. The second panel may be spaced apart from the first panel, and the third panel may be spaced apart from the second panel. A first perimeter frame may join the first panel and the second panel, with the first perimeter frame defining a first cavity in between the first panel and the second panel. The first cavity may be substantially filled with a first liquid. A second perimeter frame may join the second panel and the third panel, with the second perimeter frame defining a second cavity in between the second panel and the third panel. The second cavity may be substantially filled with a second liquid.

When a display assembly includes a display panel and an illumination panel, the liquids filling the cavities may have refractive indices lower than that of the illumination panel. With the liquids having refractive indices lower than that of the illumination panel, more light may be trapped and/or contained within the illumination panel. This may generate a brighter image on the display panel. Further, the liquid between the display panel and the illumination panel may serve to decouple the illumination panel from the display panel, especially when the display panel includes optically lossy structures, such as EMS reflective display devices, for example.

Particular implementations of the subject matter described in this disclosure can be implemented to realize one or more of the following potential advantages. The display assemblies disclosed herein may have fewer defects than display assemblies fabricated with other processes. The display assemblies disclosed herein also may be thinner than other display assemblies. Further, a film adhesive of low refractive index may be used in the fabrication of some display assemblies. Some film adhesives having a low refractive index, however, may have poor adhesion properties. Joining two panels of a display assembly with a perimeter frame and filling the cavity formed by the two panels with a low refractive index liquid may allow for the decoupling of the mechanical and optical properties of the material between the two panels.

An example of a suitable electromechanical systems (EMS) or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

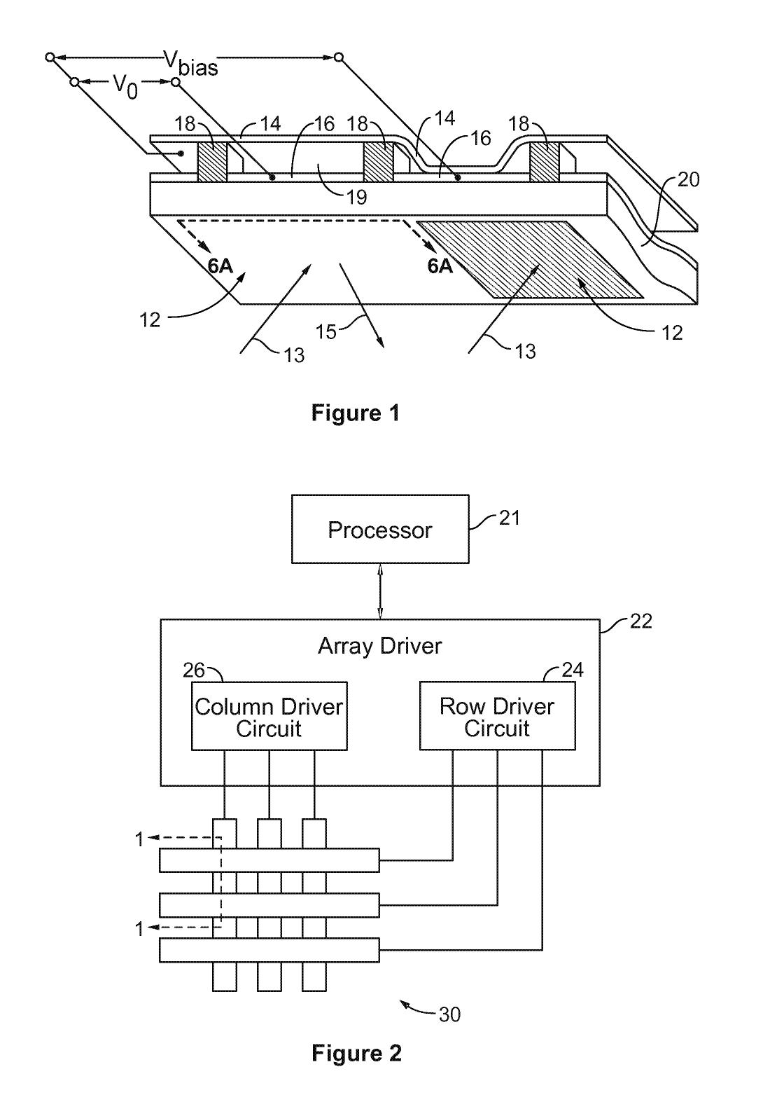

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the IMOD 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the IMOD 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be approximately 1-1000 um, while the gap 19 may be less than 10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the IMOD 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated IMOD 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

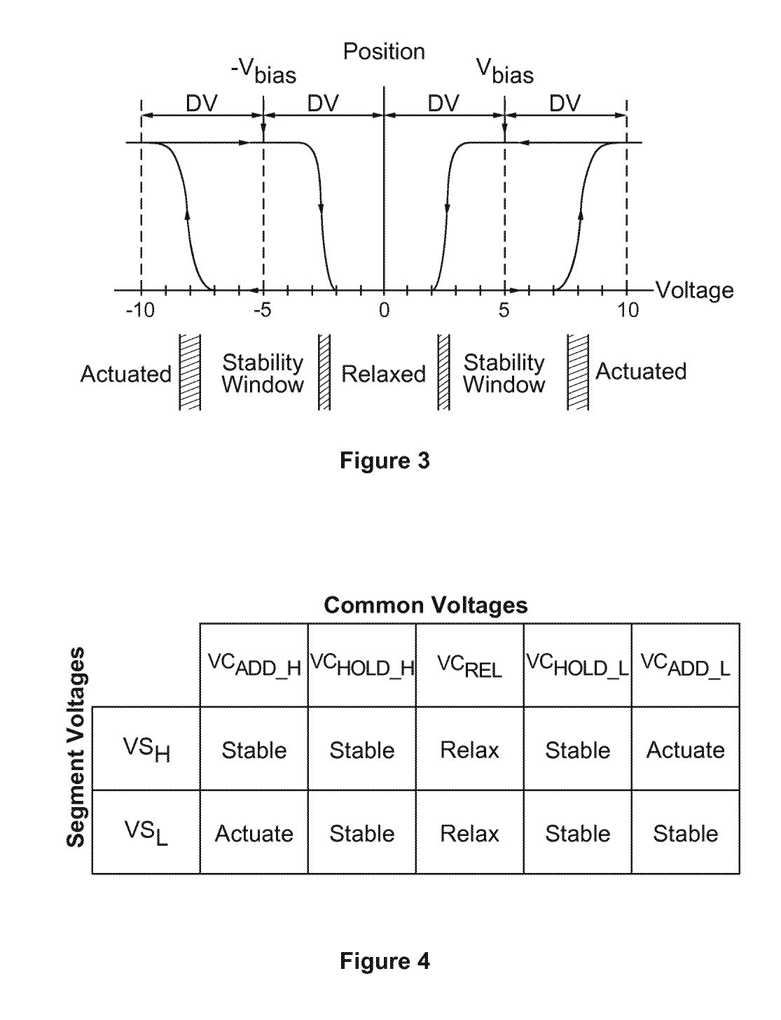

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10 volts, however, the movable reflective layer does not relax completely until the voltage drops below 2 volts. Thus, a range of voltage, approximately 3 to 7 volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10 volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7 volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

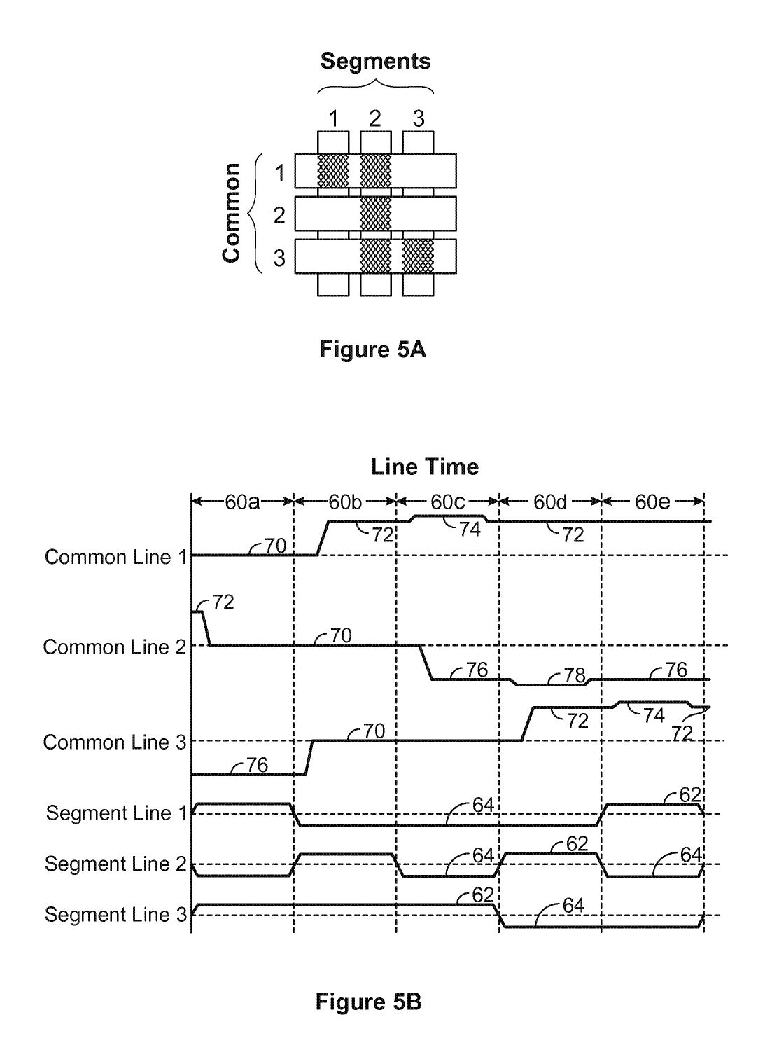

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}−relax and VC_{HOLD}_{_{—}}_{L}−stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

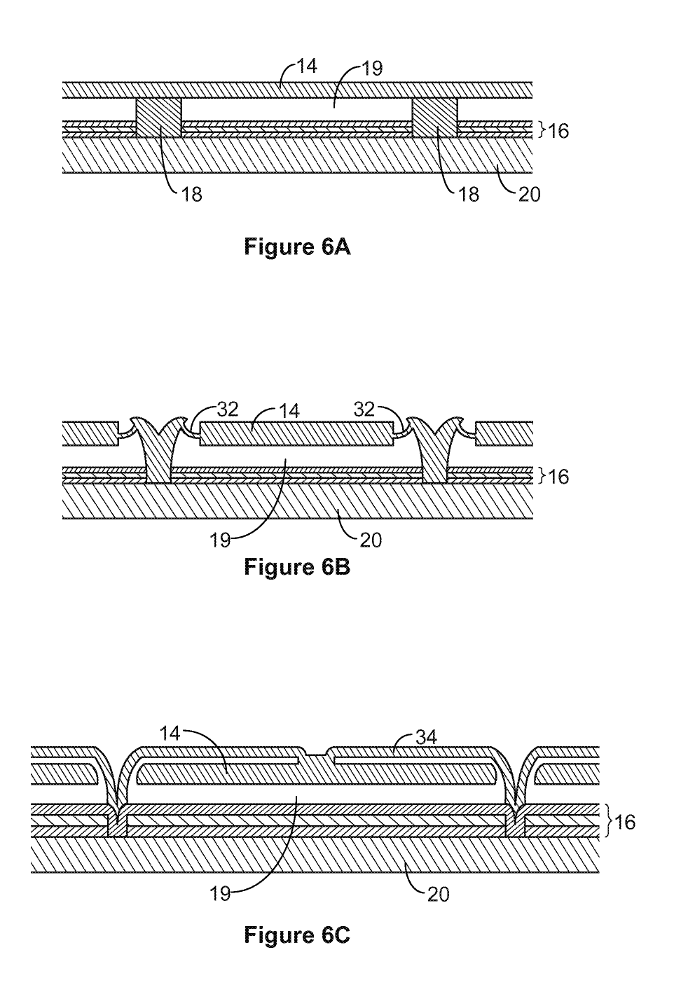

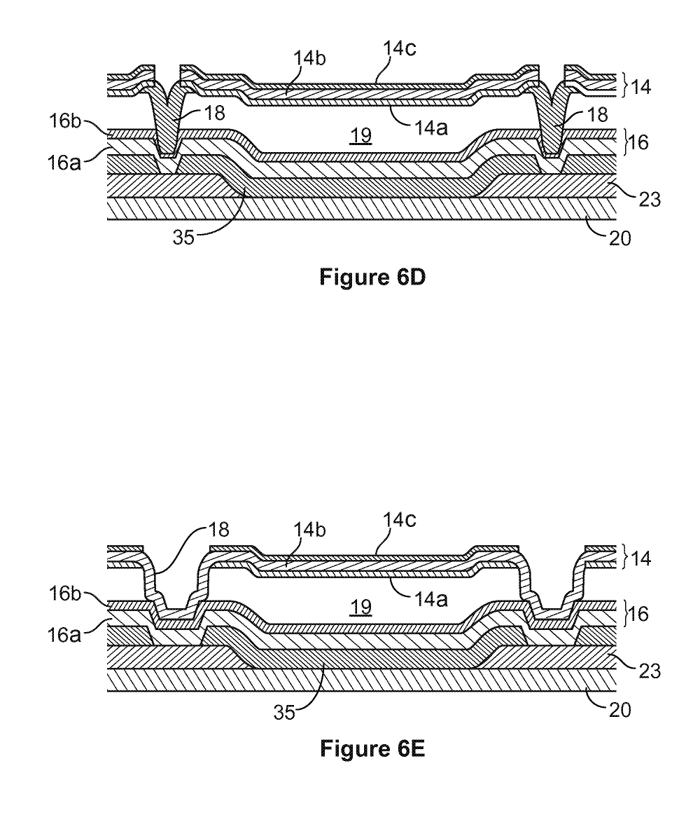

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, an SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, an SiO₂ layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self-supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

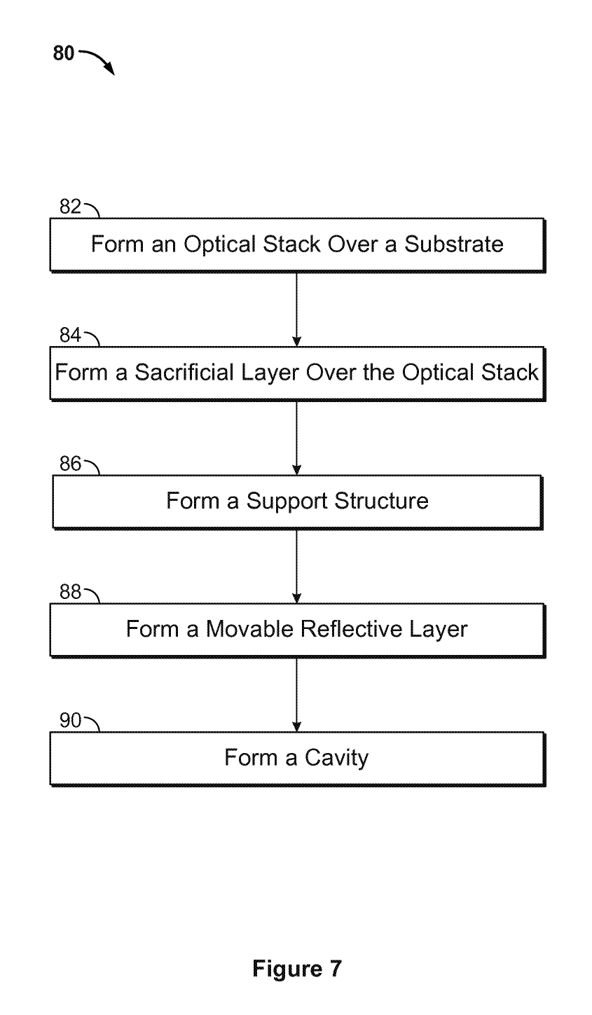

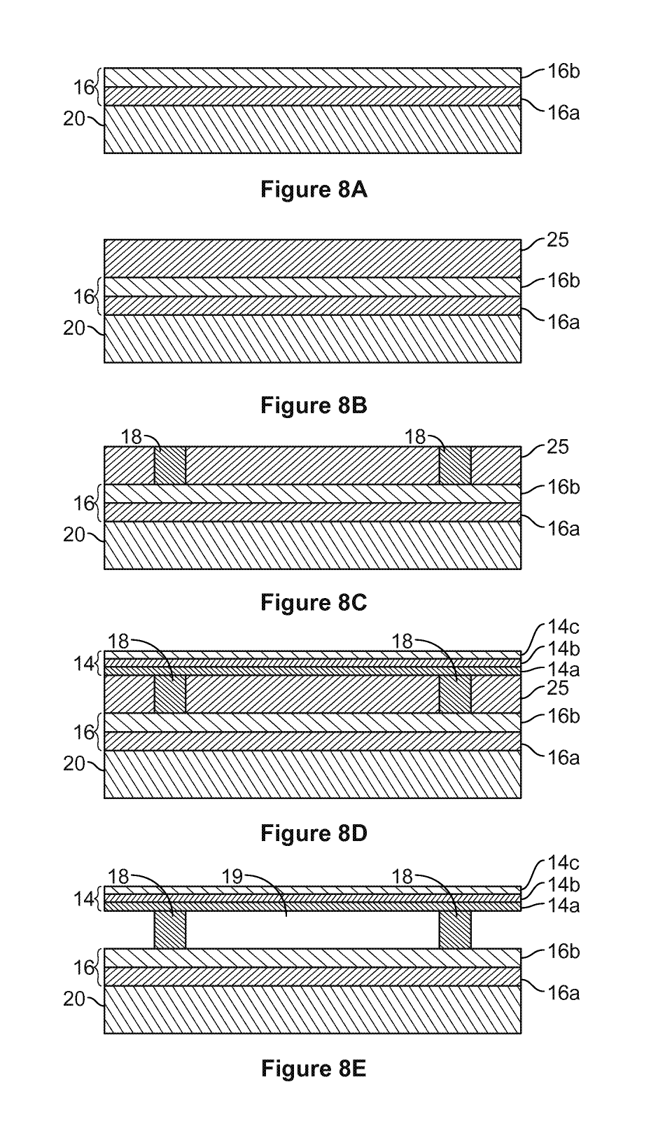

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning to remove portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition processes, e.g., reflective layer (e.g., aluminum, aluminum alloy) deposition, along with one or more patterning, masking, and/or etching processes. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other combinations of etchable sacrificial material and etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

Different manufacturing processes may be used to manufacture a display assembly. For example, a display assembly may be manufactured by applying a film adhesive or a liquid bonding material on one panel of the display assembly and placing another panel into contact with the film adhesive or bonding material, thereby laminating or bonding the two panels to one another. To manufacture a display assembly having multiple panels, the lamination or bonding may need to be performed multiple times, possibly with different types of film adhesives or liquid bonding materials, depending on the panels being joined. Dust and/or air bubbles may be trapped between two panels during the lamination and bonding processes, resulting in defects in the display assembly.

To solve the above problem, some alternative processes are proposed herein to manufacture display assemblies, with each display assembly having at least two panels. For example, a perimeter frame may be formed on one panel. Another panel may be attached to the perimeter frame, forming a cavity in between the two panels. The perimeter frame may have one or more openings allowing access to the cavity. The cavity may be filled with a liquid. In some implementations the liquid may have optical properties and/or mechanical properties tailored to the optical properties and/or mechanical properties of the two panels. In some other implementations, the liquid may be treated to alter the physical properties of the liquid during manufacturing. In some implementations, the liquid may be a liquid adhesive.

These alternative processes may be more practical and feasible in some implementations than lamination processes. For example, the alternative processes include fewer interfaces, and hence improved yield and reliability. Further, the alternative processes may be faster, resulting in shorter cycle times, than lamination processes.

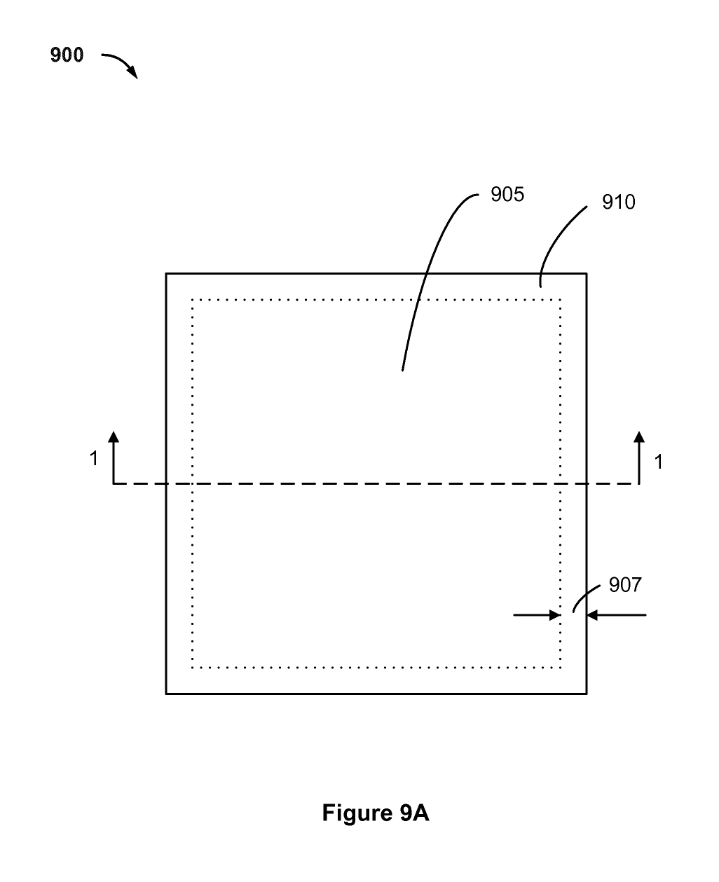

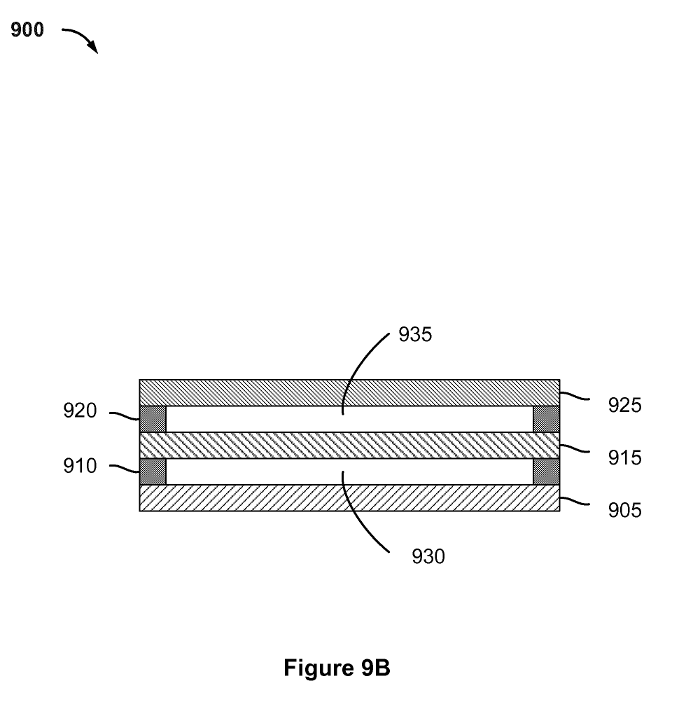

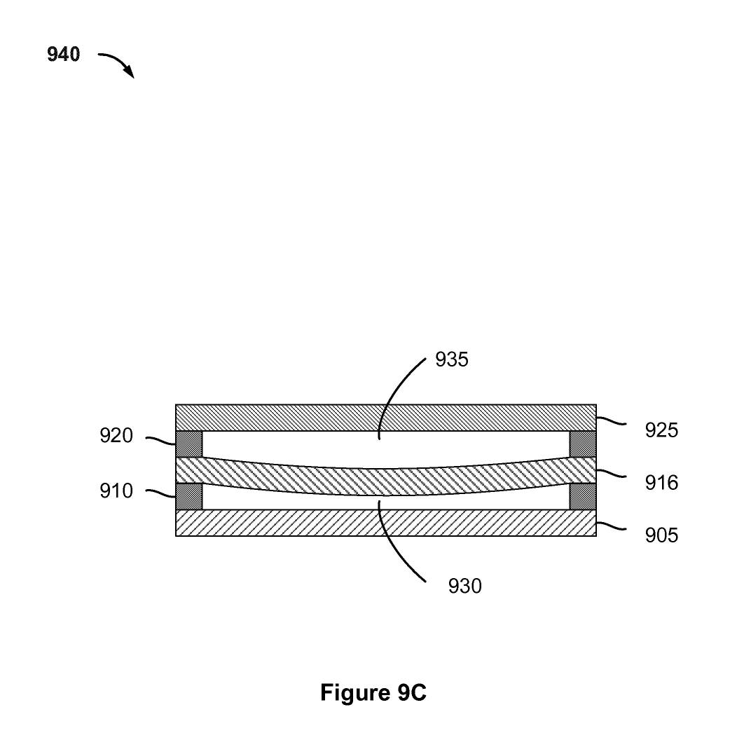

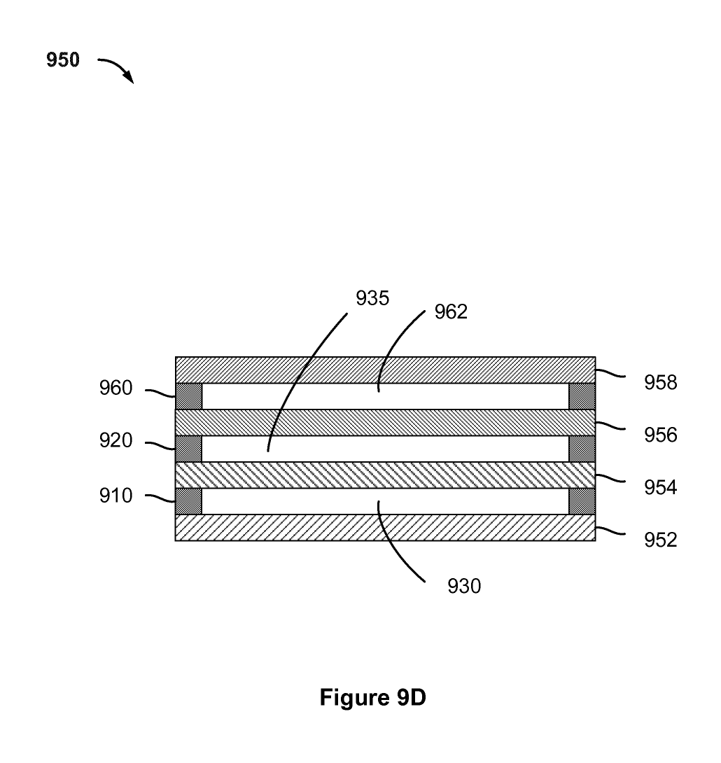

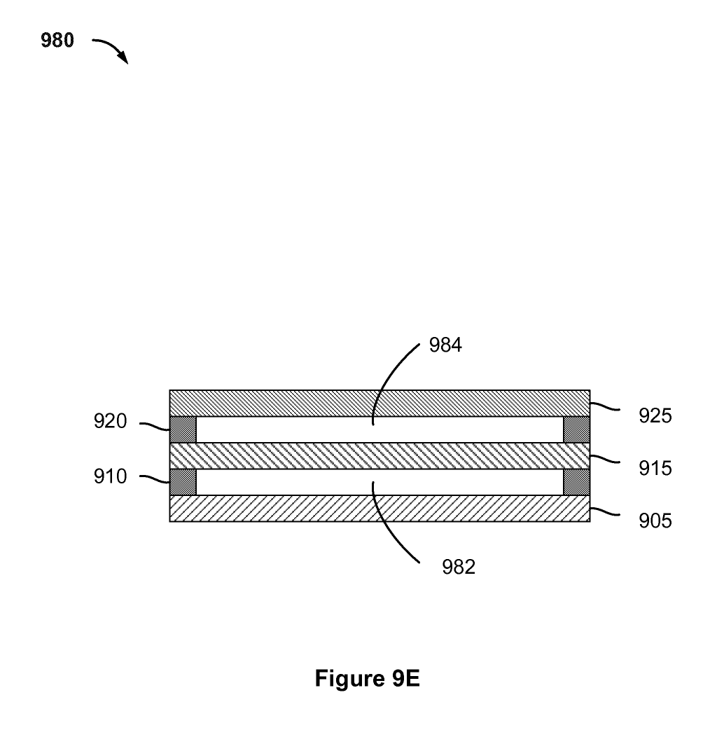

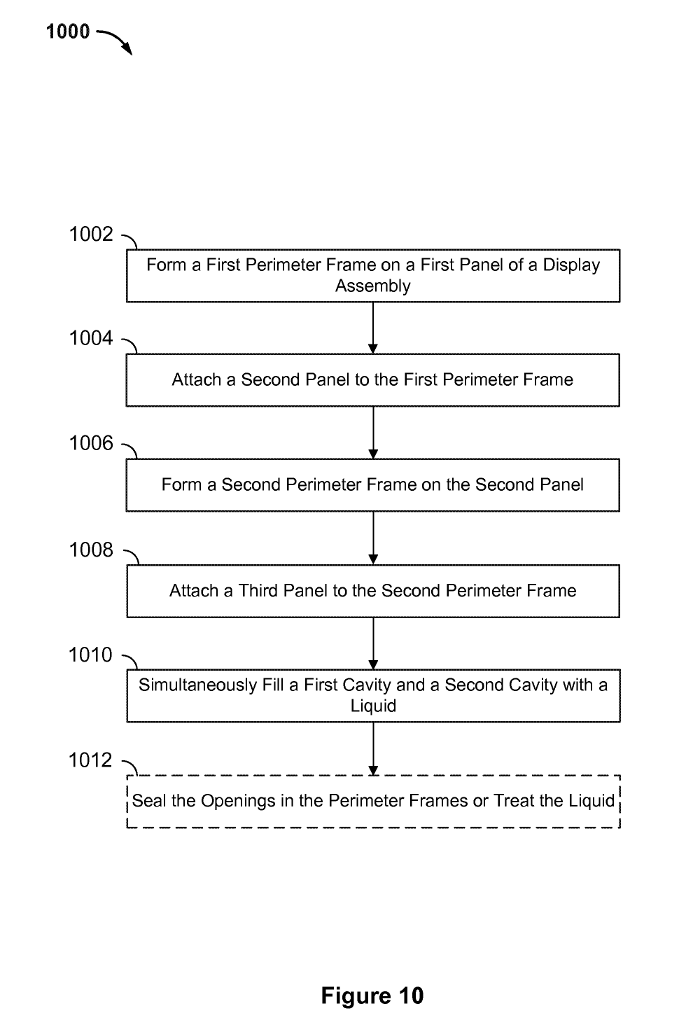

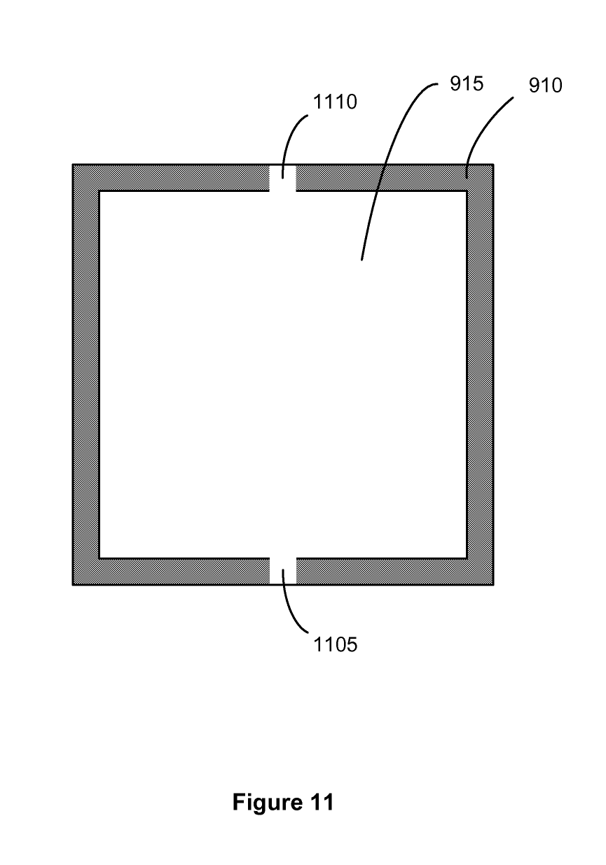

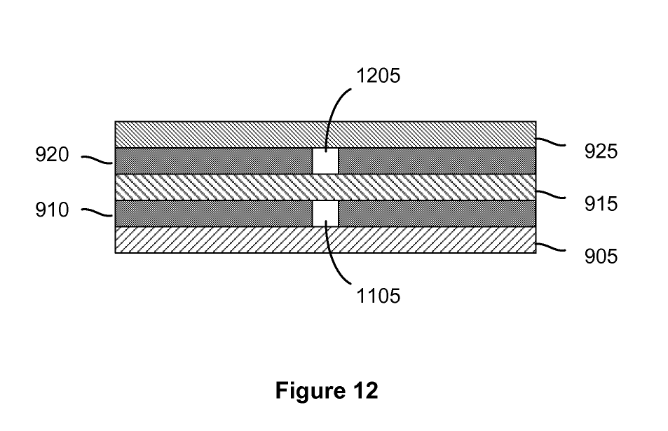

FIGS. 9A-9E show examples of schematic diagrams of display assemblies. FIG. 10 shows an example of a flow diagram illustrating a manufacturing process for a display assembly. FIGS. 11 and 12 show examples of schematic diagrams of a display assembly as described in FIG. 10 at various stages in the process.

Turning first to FIG. 9A, FIG. 9A shows an example of a bottom-up schematic diagram of a display assembly 900. The display assembly 900 includes a first panel 905. The first panel 905 may have a first perimeter frame 910 on the top surface of the first panel 905; the inner boundary of the first perimeter frame 910 is indicated by a dashed line in FIG. 9A. As shown in FIG. 9A, the first perimeter frame 910 may be along the outer perimeter or regions of the first panel 905. A width 907 of the first perimeter frame 910 may be less than about 500 microns, in some implementations.

In some implementations, the first panel 905 may include a display panel. The display panel may be capable of generating an image on the top surface of the display panel that is viewable by a user. For example, a display panel may include an array of EMS display devices, such as EMS reflective and/or EMS transreflective display devices. One type of EMS display device is an IMOD, as described herein.

While the display assembly 900 is shown as being square, the display assembly 900 may be a rectangle, circle, or oval, for example. The display assembly may have dimensions of centimeters to meters. For example, for the square display assembly 900, the diagonal of the square may have dimensions of centimeters to meters.

Turning to FIG. 9B, FIG. 9B shows an example of a cross-sectional schematic diagram of the display assembly 900. The example of the display assembly shown in FIG. 9B is a cross-sectional schematic diagram of the display assembly 900 though line 1-1 of FIG. 9A. The display assembly 900 includes the first panel 905, a second panel 915, and a third panel 925. The first perimeter frame 910 may join the first panel 905 and the second panel 915. The first perimeter frame 910 also may define a cavity between the first panel 905 and the second panel 915, with the cavity being substantially filled with a first liquid 930. A second perimeter frame 920 may join the second panel 915 and the third panel 925. The second perimeter frame 920 also may define a cavity between the second panel 915 and the third panel 925, with the cavity being substantially filled with a second liquid 935. Similar to the first perimeter frame 910, the second perimeter frame 920 may be along the outer perimeter or regions of the second panel 915. Also similar to the first perimeter frame 910, a width of the second perimeter frame 920 may be less than about 500 microns. In some implementations, the width of the first perimeter frame may be about the same as the width of the second perimeter frame. In some other implementations, the width of the first perimeter frame may be different than the width of the second perimeter frame.

As noted above, the first panel 905 may include a display panel that includes an array of EMS display devices. Some arrays of EMS display devices may use reflected light to generate an image. With these arrays of EMS display devices, however, an image may not be visible when there is little or no ambient light. To generate a visible image when there is little or no ambient light, an illumination panel may be used to shine light onto the array of EMS display devices. An illumination panel also may be referred to as a front light panel. Thus, in some implementations, the second panel 915 may include an illumination panel optically coupled to a light source. The light source may include one or more light emitting diodes (LEDs).

In some implementations, the second panel 915 may include both an illumination panel and a touch panel integrated as one panel. A touch panel, for example, is a panel that may detect the presence and location of a touch on the touch panel by an object, such as a device (e.g., a stylus) or a user's finger. Touch panels utilizing different technologies may be used to detect the presence and location of a touch, including resistive touch panels and capacitive touch panels, for example.

In some implementations, the third panel 925 may include a cover panel. The cover panel may be a thin sheet of glass, for example. In some implementations, an anti-reflective, anti-glare, anti-static thin film (not shown) or a plastic laminated film (not shown) may overlie the cover panel. In some implementations, the third panel 925 may include both a cover panel and a touch panel integrated as one panel.

In some implementations, the panels of the display assembly may be substantially flat. The panels of the display assembly 900 may be spaced apart from one another by about 5 microns to 300 microns (e.g., about 200 microns), in some implementations. For example, the first panel 905 and the second panel 915 may be spaced apart from one another by about 5 microns to 300 microns. The second panel 915 and the third panel 925 also may be spaced apart from one another by about 5 microns to 300 microns. In some implementations, the first panel 905 and the second panel 915 may be spaced apart from one another by a different spacing than the second panel 915 and the third panel 925 are spaced apart from one another.

In some implementations, the panels of the display assembly may not be substantially flat, i.e., one or more of the panels of the display assembly may be bowed or include some curvature. In some other implementations, one or more of the panels of the display assembly may not have a uniform thickness. When a panel is not substantially flat, the spacing between two panels may be about 5 microns to 300 microns at or near the perimeter frame, while the spacing between the panels may be more or less than about 5 microns to 300 microns at other regions between the panels. For example, the spacing between the panels may be more or less than about 5 microns to 300 microns near the center of the two panels.

FIG. 9C shows an example of a cross-sectional schematic diagram of a display assembly 940. The display assembly 940 shown in FIG. 9C may be similar to the display assembly 900 shown in FIG. 9B, with the second panel 915 (FIG. 9B) being replaced with a second panel 916 (FIG. 9C). The display assembly 940 includes the first panel 905, the second panel 916, and the third panel 925. The first perimeter frame 910 may join the first panel 905 and the second panel 916. The first perimeter frame 910 also may define a cavity between the first panel 905 and the second panel 916, with the cavity being substantially filled with a first liquid 930. A second perimeter frame 920 may join the second panel 916 and the third panel 925. The second perimeter frame 920 also may define a cavity between the second panel 916 and the third panel 925, with the cavity being substantially filled with a second liquid 935.

The second panel 916 is not substantially flat. The spacing between the first panel 905 and the second panel 916 may be larger at or near the perimeter frame 910 than near the center of the display assembly 940. The spacing between the second panel 916 and the third panel 925 may be smaller at or near the perimeter frame 920 than near the center of the display assembly 940.

In some implementations, the second panel 916 may be an illumination panel that is bowed or includes some curvature. In some other implementations, the second panel 916 may be an illumination panel with a non-uniform thickness across the illumination panel. An illumination panel having a non-uniform thickness may result in a wedge shaped cavity above or below the illumination panel.

While the second panel 916 is shown in FIG. 9C as being bowed or including some curvature, the first panel 905 and the third panel 925 also may be bowed, include some curvature, or not have a uniform thickness. For example, the first panel 905 may include a display panel including an array of EMS display devices, as noted above. Such a display panel may not be substantially flat, as it may be made of two layers of glass, in some implementations. These two layers of glass may be separated by an air gap that may vary in thickness across the display panel, giving the display panel some bowing or curvature. As another example, the third panel 925 may include a cover panel, as noted above. The cover panel may not be substantially flat, and may be bowed or include some curvature. In some implementations, the cover panel may include one surface that is substantially flat and one surface that is convex or concave.

The manufacturing processes disclosed herein may be better suited for manufacturing display assemblies when one or more of the panels is bowed, includes some curvature, or has a non-uniform thickness. For example, a liquid being flowed between the panels of a display assembly, as described further below, may completely fill the cavity between the two panels and displace air inside the cavity. In contrast, when bowed panels, panels including some curvature, or panels having a non-uniform thickness are incorporated into display assemblies using conventional manufacturing processes, these processes may leave air inside the cavity between two panels.

Turning back to FIG. 9B, the first perimeter frame 910 and the second perimeter frame 920 may include a number of different materials. In some implementations, the first perimeter frame 910 and the second perimeter frame 920 may include a liquid adhesive (e.g., epoxy) or a pressure sensitive adhesive. Depending on the material used to make the perimeter frames 910 and 920, the perimeter frame may be treated to bond one panel to another panel. For example, when the perimeter frames 910 and 920 include an epoxy, heat or ultraviolet (UV) light may be used to treat the perimeter frames. As another example, when the perimeter frame includes a pressure sensitive adhesive, pressure may be applied to a panel to bond it to the perimeter frame.

In some implementations, the perimeter frames 910 and 920 also may include a spacer material. The spacer material may include particles of material having a dimension of the size of the spacing desired between two panels. For example, when a spacing of about 200 microns is desired between two panels at the perimeter frame, the perimeter frame may include spheres of material having a diameter of about 200 microns. The spheres of material may be glass spheres or polymer spheres, for example. These spheres of material may aid in obtaining a spacing of about 200 microns between the two panels during the manufacturing process.

The first liquid 930 and the second liquid 935 may include a number of different types of liquids. In some implementations of the display assembly 900, the first liquid 930 and the second liquid 935 may be the same liquids, and in some other implementations, the first liquid 930 and the second liquid 935 may be different liquids. In some implementations, the operation of an illumination panel or a front light panel may be improved by the first liquid 930 or the second liquid 935.

For example, when the first panel 905 includes a display panel and the second panel 915 includes an illumination panel, the first liquid 930 and/or the second liquid 935 may be liquids having refractive indices lower than that of the illumination panel, in some implementations. With the first liquid 930 and/or the second liquid 935 having refractive indices lower than that of the illumination panel, more light may be trapped and/or contained within the illumination panel. This may generate a brighter image on the display panel. Further, the liquid layer between the display panel and the illumination panel may serve to decouple the illumination panel from the display panel, especially when the display panel includes optically lossy structures, such as EMS reflective display devices, for example. Optically lossy structures may be structures that cause attenuation or dissipation of light, for example.

In some implementations, the liquids 930 and 935 include non-curable liquids, and in some other implementations, the liquids 930 and 935 include curable liquids. Treating a curable liquid may transform, harden, or solidify the liquid, making it a solid. Curable liquids include UV curable liquids and thermally curable liquids. Curable liquids are discussed further below with respect to FIG. 12.

A non-curable liquid in a display assembly may have a number of specified properties, including the index of refraction, transparency, and mechanical properties (e.g., shock absorbing properties). In some implementations, the liquids 930 and 935 may have a low index of refraction. For example, the index of refraction of the liquids 930 and 935 may be within a range of about 1.3 to 1.6. In some implementations, a liquid having an index of refraction matching the index of refraction of an adjacent panel may be chosen. For example, the index of refraction of the liquids 930 and 935 may be about 1.52, which is the index of refraction of glass. In some implementations, the liquids 930 and 935 may be substantially transparent. For example, the light transmission in the visible spectrum for the liquids 930 and 935 may be about 85% or greater.

In some other implementations, when the liquids 930 and 935 function as a diffuser, the liquid may have optical absorbing properties. For example, the liquids 930 and 935 may absorb UV light, in some implementations. In some implementations, diffusive particles may be added to the liquids 930 and 935. In some implementations, the liquids 930 and 935 may have a bulk modulus of about 100 megapascals to a few gigapascals, which may give the liquid shock absorbing characteristics.

In some implementations, the non-curable liquid may be a silicon oil (i.e., a polymerized siloxane with organic side chains), a fluorinated solvent (e.g., perfluorohexane (C₆F₁₄)), or water. Silicon oils, for example, may have low surface energies and low indices of refraction (e.g., about 1.4). Fluorinated solvents and water, for example, may have low indices of refraction (e.g., about 1.4). In some implementations, other liquids may be added to water to provide temperature stability (e.g., to raise the boiling point of water (e.g., by about 10° C.), or to lower the freezing point of water) or to modify the viscosity of water. Lowering the freezing point of water may aid in preventing the water from freezing, which could fracture the display assembly due to the expansion of the water.

The first liquid 930 and the second liquid 935 may be incorporated in the display assembly 900 with different techniques. In some implementations, during the manufacturing process of the display assembly 900, the first perimeter frame 910 may include an opening. The first liquid 930 may be flowed into the cavity through the first opening to substantially fill the cavity. In some implementations, the first opening may be sealed after the first liquid 930 is flowed into the cavity through the first opening. Similarly, the second perimeter frame 935 may include a second opening. The second liquid may be flowed into the cavity through the second opening to substantially fill the cavity. In some implementation, the second opening may be sealed after the second liquid 935 is flowed into the cavity through the second opening.

In some other implementations, the liquids 930 and 935 may heated before the liquids are flowed into the cavities. Once the liquids 930 and 935 are in the cavities, the liquids 930 and 935 may be cooled down. Upon cooling, the liquids 930 and 935 may solidify or transform to a gel. In these implementations, the first and the second openings may not need to be sealed, as the solidified liquid or gel may not flow. A manufacturing process for a display assembly is described further below with respect to FIG. 10.

While the display assembly 900 is shown as including only three panels, a display assembly may include more than three panels, with additional perimeter frames joining the panels and liquids filling the cavities defined by the perimeter frames and the cavities. For example, when an illumination panel and a touch panel are not integrated in the same panel, the display assembly may include four panels, namely, a display panel, an illumination panel, a touch panel, and a cover panel.

FIG. 9D shows an example of a cross-sectional schematic diagram of a display assembly including four panels. The display assembly 950 includes a display panel 952, an illumination panel 954, a touch panel 956, and a cover panel 958. A first perimeter frame 910 may join the display panel 952 and the illumination panel 954. The first perimeter frame 910 may define a cavity between the display panel 952 and the illumination panel 954, with the cavity being substantially filled with a first liquid 930. A second perimeter frame may join the illumination panel 954 and the touch panel 956. The second perimeter frame 920 may define a cavity between the illumination panel 954 and the touch panel 956, with the cavity being substantially filled with a second liquid 935. A third perimeter frame 960 may define a cavity between the touch panel 956 and the cover panel 958, with the cavity being substantially filled with a third liquid 962. In some implementations, the third perimeter frame 960 may be similar to the first perimeter frame 910 or the second perimeter frame 920. In some implementations, the third liquid 962 may be similar to the first liquid 930 or the second liquid 935.

Another implementation of a display assembly is shown in FIG. 9E. FIG. 9E shows an example of a cross-sectional schematic diagram of a display assembly. A display assembly 980 shown in FIG. 9E may be similar to the display assembly 900 shown in FIGS. 9A and 9B, with one difference being that the display assembly 980 may include solid layers 982 and 984 between the panels of the display assembly, rather than liquids as in the display assembly 900. The solid layers 982 and 984 may be formed from curable liquids, as further discussed below. In some implementations, the display assembly 980 includes a first panel 905, a second panel 915, and a third panel 925. A first perimeter frame 910 may join the first panel 905 and the second panel 915. The first perimeter frame 910 may define a cavity between the first panel 905 and the second panel 915, with the cavity being substantially filled with a first solid layer 982. A second perimeter frame 920 may join the second panel 915 and the third panel 925. The second perimeter frame 920 may define a cavity between the second panel 915 and the third panel 925, with the cavity being substantially filled with a second solid layer 984. In some implementations, the first solid layer 982 and the second solid layer 984 may be the same materials, and in some other implementations, the first solid layer 982 and the second solid layer 984 may be the different materials.

The solid layers of the display assembly 980 may be about 5 microns to 300 microns thick (e.g., about 200 microns), in some implementations. For example, the first solid layer 982 may be about 5 microns to 300 microns thick. The second solid layer 984 also may be about 5 microns to 300 microns thick. In some implementations, the solid layers of the display assembly 980 may not have a uniform thickness. For example, a solid layer may be about 5 microns to 300 microns thick at or near the perimeter frame, while the solid layer may be thicker or thinner than about 5 microns to 300 microns at other regions of the solid layer.

The first solid layer 982 and the second solid layer 984 may be incorporated in the display assembly 980 with different techniques. In some implementations, the first solid layer 982 and the second solid layer 984 may be formed from curable liquids. In some implementations, during the manufacturing process of the display assembly 900, the first perimeter 910 frame may include an opening. A curable liquid may be flowed into the cavity through the first opening to substantially fill the cavity. Similarly, the second perimeter frame 935 may include a second opening. A curable liquid may be flowed into the cavity through the second opening to substantially fill the cavity. The liquids may then be treated to form the first solid layer 982 and the second solid layer 984. In some implementations, the treatment may be a heat treatment, and in some other implementations, the treatment may be a UV light treatment. A manufacturing process for a display assembly is described further below with respect to FIG. 10.

A solid layer in a display assembly may have a number of specified properties, including the index of refraction, transparency, and mechanical properties (e.g., shock absorbing properties). In some implementations, the solid layers 982 and 984 may have a low index of refraction. For example, the index of refraction of the solid layers 982 and 984 may be within a range of about 1.3 to 1.6. In some implementations, a solid having an index of refraction matching the index of refraction of an adjacent panel may be chosen. For example, the index of refraction of the solid layers 982 and 984 may be about 1.52, which is the index of refraction of glass. When a liquid is cured to form a solid layer, the refractive index of the liquid versus the solid layer may differ by about 1%.

In some implementations, the solid layers 982 and 984 may be substantially transparent. For example, the light transmission in the visible spectrum for the solid layers 982 and 984 may be about 85% or greater. In some implementations, the solid layers 982 and 984 may have an elastic modulus of about 100 megapascals to a few gigapascals, which may give the solid layer shock absorbing characteristics. As such, the solid layers 982 and 984 may protect the panels 905, 915, and 925 from external pressure or impact.

In some implementations, the solid layer may include a gel, a polymer, or a glassy solid. A gel, for example, may be a substantially dilute cross-linked material that exhibits no flow. Specific examples of a solid layer include an epoxy layer, an aerogel layer, and a polyurethane layer.

While the display assemblies shown in FIGS. 9A-9E include either liquid layers or solid layers, a display assembly may include a liquid layer or layers and a solid layer or layers. For example, the display assembly 900 shown in FIGS. 9A and 9B may include a liquid layer between two panels and a solid layer between two panels. Further, while the display assemblies shown in FIGS. 9A-9E include three or four panels, a display assembly may include two panels or five or more panels. Liquid layers and/or solid layers may be between the panels of the display assembly.

FIG. 10 shows an example of a flow diagram illustrating a manufacturing process for a display assembly. Operations of the process 1000 shown in FIG. 10 may be used to form the display assemblies shown in FIG. 9A-9E.

Starting at block 1002 of the process 1000, a first perimeter frame is formed on a first panel of a display assembly. The first panel may be any panel of a display assembly, including a display panel, an illumination panel, a touch panel, or a cover panel. As noted herein, the first perimeter frame may include a liquid adhesive or a pressure sensitive adhesive, for example. The first perimeter frame may be formed on the perimeter of a surface of the first panel. The first perimeter frame may be formed on the first panel with a screen printing process or otherwise be applied to the first panel.

At block 1004, a second panel is attached to the first perimeter frame. The first panel, the second panel, and the first perimeter frame may define a first cavity. The first perimeter frame may include a first opening and a second opening to allow access to the first cavity. The second panel may be any panel of a display assembly, including a display panel, an illumination panel, a touch panel, or a cover panel. As noted herein, when the first perimeter frame includes an epoxy, heat or ultraviolet (UV) light may be used to treat the first perimeter frame and bond the first panel to the second panel. When the first perimeter frame includes a pressure sensitive adhesive, pressure may be applied to the second panel to bond it to the perimeter frame. Further, the perimeter frame also may include a spacer material to aid in obtaining a desired spacing between the first panel and the second panel at the first perimeter frame.

Turning to FIG. 11, FIG. 11 shows an example of a top-down schematic diagram of a partially fabricated display assembly at this point (e.g., up through block 1004) in the process 1000. A second panel 915 of the partially fabricated display assembly as shown in FIG. 11 is transparent such that an underlying perimeter frame 910 is visible. The perimeter frame 910 includes a first opening 1105 and a second opening 1110 to allow access to the first cavity formed by the first panel (not shown), the perimeter frame 910, and the second panel 915.

At block 1006, a second perimeter frame is formed on the second panel. In some implementations, the second perimeter frame may be similar to the first perimeter frame. For example, the second perimeter frame may include a liquid adhesive or a pressure sensitive adhesive. The second perimeter frame may be formed on the perimeter of a surface of the second panel. The second perimeter frame may formed on the second panel with a screen printing process or otherwise be applied to the second panel.

At block 1008, a third panel is attached to the second perimeter frame. The second panel, the third panel, and the second perimeter frame may define a second cavity. The second perimeter frame may include a third opening and a fourth opening to allow access to the second cavity. The third panel may be any panel of a display assembly, including a display panel, an illumination panel, a touch panel, or a cover panel. Similar to the first perimeter frame, the second perimeter frame may include spacer materials. Depending on the material included in the second perimeter frame, heat, UV light, or pressure may be used to bond the third panel to the second perimeter frame.

Turning to FIG. 12, FIG. 12 shows an example of a schematic diagram of an edge a partially fabricated display assembly at this point (e.g., up through block 1008) in the process 1000. The partially fabricated display assembly includes the first panel 905, the second panel 915, and a third panel 925. The first perimeter frame 910 is between the first panel 905 and the second panel 915, and the second perimeter frame 920 is between the second panel 915 and the third panel 925. The first perimeter frame 910 includes the first opening 1105 to allow access to the first cavity formed by the first panel 905, the first perimeter frame 910, and the second panel 915. The second perimeter frame 920 includes a third opening 1205 to allow access to the second cavity formed by the second panel 915, the second perimeter frame 920, and the third panel 925. The openings 1105 and 1205 and the other openings may have dimensions of about 1 millimeter to 5 millimeters. Further, the dimensions of the openings 1105 and 1205 and the other openings may or may not be the same.

At block 1010, the first cavity and the second cavity are simultaneously filled with a liquid. The first cavity and the second cavity may be filled with a liquid using the openings in the perimeter frames. The first cavity and the second cavity may be substantially filled with the liquid. Simultaneously filling the first cavity and the second cavity with a liquid may aid in speeding up the manufacturing process 1000.

Different methods may be used to simultaneously fill the first cavity and the second cavity with a liquid. In some implementations, a liquid may be flowed into the first opening 1105 and the third opening 1205 and out of the second opening 1110 and the fourth opening (not shown). For example, the liquid may be poured into the first opening 1105 and the third opening 1205. When the flow rate of the liquid into a cavity is greater than the flow rate out of the cavity, the cavity will become filled with the liquid. Flowing the liquid though the cavities in this manner for a period of time may aid in removing air bubbles from the liquid or aid in substantially filling the cavities with the liquid, for example.

In some implementations, a liquid may be forced into the first cavity and the second cavity though the first opening 1105 and the third opening 1205, respectively, with pressure. For example, the liquid may be injected into the first cavity and the second cavity using syringes. In some other implementations, a vacuum may be applied to the first opening 1105 and the third opening 1205 to suck the liquid into the cavity through the second opening 1110 and the fourth opening. In some implementations, a liquid may fill the first cavity and the second cavity through a capillary action mechanism.

In some other implementations, a perimeter frame may include one opening or more than two openings. When a perimeter frame includes two or more openings, the openings may be arranged in various configurations. For example, as shown in FIG. 11, the openings may be on different sides of the perimeter frame. In some implementations, the openings may be on the same side of a perimeter frame. When a perimeter frame includes more than two openings, one opening may be used for flowing the liquid into the cavity, with multiple openings having the liquid flowing out of the cavity to substantially fill the cavity, for example. Alternatively, multiple openings may have the liquid flowing into of the cavity, with one opening having the liquid flowing out of the cavity, for example.

In some implementations, the rheology of the liquid may be tailored to aid in the liquid filling a cavity. Further, the rheology of the liquid may be specified depending on the process used to fill a cavity. For example, when filling a cavity by applying pressure to a liquid, the viscosity of the liquid may be selected, at least in part, based on the pressure to be applied.

Returning to FIG. 10, in some implementations, after filling the first cavity and the second cavity with a liquid at block 1010, at block 1012 the first opening in the first perimeter frame and the second opening in the second perimeter frame optionally may be sealed. Sealing these openings may prevent the liquid from flowing out of the first cavity and the second cavity. The openings may be sealed when the liquid is a non-curable liquid, for example. When a curable liquid is used to fill the first cavity and the second cavity, however, the first opening and the second opening may not need to be sealed as the liquid may be transformed to a solid, as described below. An opening may be sealed with the same material of the perimeter frame, for example. An opening also may be sealed with a liquid adhesive, for example.

In some other implementations, after filling the first cavity and the second cavity with a liquid at block 1010, at block 1012 the liquid optionally may be treated to alter the physical properties of the liquid. In some implementations, treating the liquid may include a heat treatment or a UV light treatment. In some implementations, when one of the panels absorbs or reflects UV light, a heat treatment may be used instead of a UV light treatment so that the liquid may be exposed to the treatment. For example, when the display assembly includes regions corresponding to black borders on the panels of the display assembly, a heat treatment may be used. Treating the liquid may be performed when the liquid is a curable liquid, for example. Treating the liquid, as described herein, may transform the liquid into a solid layer including a gel, a polymer, or a glassy solid, for example. A heat treatment or a UV light treatment may cause a monomer liquid to cross-link and form a polymer solid, for example. The change in the physical properties of the liquid may be such that the liquid will not flow out of the cavities, obviating the need to seal the openings in the perimeter frames.

In some other implementations, the first cavity and the second cavity may be filled with a heated liquid at block 1010. After filling the first cavity and the second cavity with the heated liquid, the liquid may be allowed to cool. Upon cooling, the liquid may solidify or transform to a gel.

While the manufacturing process 1000 shown in FIG. 10 is for a display assembly including three panels, additional panels could be added to the display assembly. For example, an additional panel and an additional frame could be used to form a display assembly including four or more panels. All of the cavities formed by the panels and the perimeter frames could be filled with a liquid simultaneously.

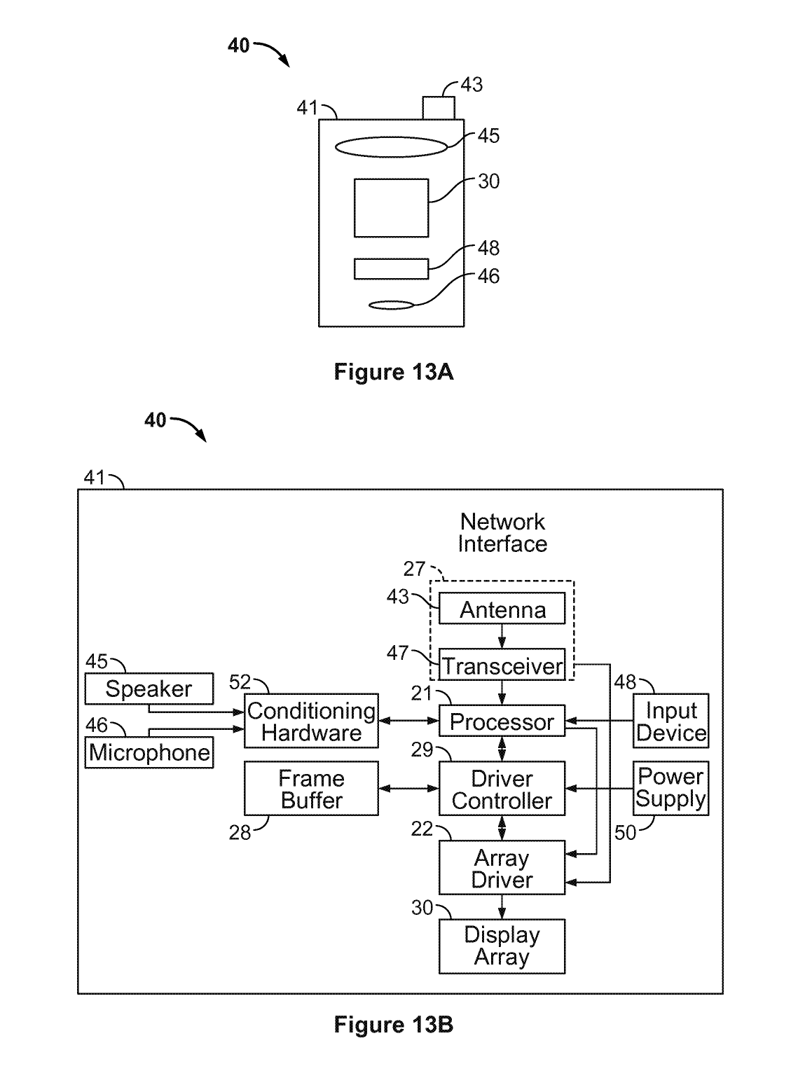

FIGS. 13A and 13B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 13B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1× EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those having ordinary skill in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A display assembly comprising:
a first panel;
a second panel spaced apart from the first panel;
a third panel spaced apart from the second panel;
a first perimeter frame joining the first panel and the second panel, the first perimeter frame defining a first cavity in between the first panel and the second panel, the first cavity being substantially filled with a first liquid; and
a second perimeter frame joining the second panel and the third panel, the second perimeter frame defining a second cavity in between the second panel and the third panel, the second cavity being substantially filled with a second liquid.

2. The display assembly of claim 1, wherein the second panel is spaced apart from the first panel by about 5 microns to 300 microns, and wherein the third panel is spaced apart from the second panel by about 5 microns to 300 microns.

3. The display assembly of claim 1, wherein the first panel includes a display panel and the second panel includes an illumination panel.

4. The display assembly of claim 3, wherein the illumination panel is optically coupled to a light source to illuminate the display panel.

5. The display assembly of claim 3, wherein the third panel includes at least one of a touch panel and a cover panel.

6. The display assembly of claim 1, wherein the first liquid and the second liquid are the same liquids.

7. The display assembly of claim 1, wherein the first perimeter frame includes a first opening, wherein the first liquid is flowed into the first cavity through the first opening to substantially fill the first cavity, wherein the second perimeter frame includes a second opening, and wherein the second liquid is flowed into the second cavity through the second opening to substantially fill the second cavity.

8. The display assembly of claim 7, wherein the first opening is sealed after the first liquid is flowed into the first cavity through the first opening to substantially fill the first cavity, and wherein the second opening is sealed after the second liquid is flowed into the second cavity through the second opening to substantially fill the second cavity.

9. The display assembly of claim 1, wherein the first liquid and the second liquid have an index of refraction within a range of about 1.3 to 1.6.

10. The display assembly of claim 1, wherein the light transmission in the visible spectrum of the first liquid and the second liquid is about 85% or greater.

11. The display assembly of claim 1, wherein at least one of the panels is bowed.

12. A system including the display assembly of claim 1, wherein the display assembly is part of a display, the system further comprising:
a processor that is configured to communicate with the display, the processor being configured to process image data; and
a memory device that is configured to communicate with the processor.

13. The system of claim 12, further comprising:
a driver circuit configured to send at least one signal to the display; and
a controller configured to send at least a portion of the image data to the driver circuit.

14. The system of claim 12, further comprising:
an image source module configured to send the image data to the processor.

15. The system of claim 14, wherein the image source module includes at least one of a receiver, transceiver, and transmitter.

16. The system of claim 12, further comprising:
an input device configured to receive input data and to communicate the input data to the processor.

17. A display assembly comprising:
a first panel;
a second panel;
a third panel;
a first perimeter frame joining the first panel and the second panel, the first perimeter frame defining a first cavity in between the first panel and the second panel, the first cavity being substantially filled with a first solid; and
a second perimeter frame joining the second panel and the third panel, the second perimeter frame defining a second cavity in between the second panel and the third panel, the second cavity being substantially filled with a second solid.

18. The display assembly of claim 17, wherein the first solid is about 5 microns to 300 microns thick, and wherein the second solid is about 5 microns to 300 microns thick.

19. The display assembly of claim 17, wherein the first solid and the second solid are the same materials.

20. The display assembly of claim 17, wherein the first perimeter frame includes a first opening, wherein a first liquid is flowed into the first cavity through the first opening to substantially fill the first cavity, wherein the second perimeter frame includes a second opening, wherein a second liquid is flowed into the second cavity through the second opening to substantially fill the second cavity, and wherein the first liquid and the second liquid are treated to form the first solid and the second solid, respectively.

21. The display assembly of claim 20, wherein a treatment of the first liquid and the second liquid includes at least one of a heat treatment and an ultraviolet light treatment.

22. The display assembly of claim 17, wherein the first solid and the second solid have an index of refraction within a range of about 1.3 to 1.6, and wherein the light transmission in the visible spectrum of the first solid and the second solid is about 85% or greater

23. The display assembly of claim 17, wherein the first panel includes a display panel and the second panel includes an illumination panel.

24. The display assembly of claim 23, wherein the illumination panel is optically coupled to a light source to illuminate the display panel.

25. A method comprising:
forming a first perimeter frame on a first panel of a display assembly;
attaching a second panel to the first perimeter frame, wherein the first panel, the second panel, and the first perimeter frame form a first cavity, and wherein the first perimeter frame includes a first opening to allow access to the first cavity;
forming a second perimeter frame on the second panel;
attaching a third panel to the second perimeter frame, wherein the second panel, the third panel, and the second perimeter frame form a second cavity, and wherein the second perimeter frame includes a second opening to allow access to the second cavity; and
simultaneously filling the first cavity and the second cavity with a liquid using the first opening and the second opening to substantially fill the first cavity and the second cavity.

26. The method of claim 25, further comprising:
after filling the first cavity and the second cavity with the liquid, treating the liquid to alter the physical properties of the liquid.

27. The method of claim 26, wherein treating the liquid includes at least one of a heat treatment and an ultraviolet light treatment.

28. The method of claim 25, further comprising:
after filling the first cavity and the second cavity with the liquid, sealing the first opening and sealing the second opening.

29. The method of claim 25, wherein the first panel includes a display panel and the second panel includes an illumination panel, and wherein the illumination panel is optically coupled to a light source to illuminate the display panel.
